(19) United States
(12) Patent Application Publication
(10) Pub. No.: US 2021/0170897 A1
(43) Pub. Date: Jun. 10, 2021

(54) SWIFT CHARGE MOBILE STORAGE

(71) Applicant: GREEN MACHINE POWER LLC, Phoenix, AZ (US)

(72) Inventor: Erik Ellis, Phoenix, AZ (US)

(73) Assignee: GREEN MACHINE POWER LLC, Phoenix, AZ (US)

(21) Appl. No.: 17/181,844

(22) Filed: Feb. 22, 2021

Related U.S. Application Data
(63) Continuation of application No. PCT/US2019/049282, filed on Sep. 3, 2019.
(60) Provisional application No. 62/726,901, filed on Sep. 4, 2018.

(51) Int. Cl. B60L 53/53; B60L 53/63; B60L 53/64; B60L 53/68

(52) U.S. Cl. CPC B60L 53/53; B60L 53/63; B60L 53/11; B60L 53/68; B60L 53/64

(57) ABSTRACT

A mobile, energy-storing DC fast charger may be easily moved from a low-cost charging hub to a different secondary vehicle-charging location. This allows grid charging to occur at a remote, low-cost location that does not require the electrical service upgrades that would be necessary for construction of a new charging station at a location where it is desired to serve EV customers. Once charged at the low-cost hub, a mobile unit may be delivered to various remote locations for charging of electric vehicles at a low total lifecycle cost. The mobile units may be configured to provide AC and DC services for electric customers in addition to the EV services. Examples of such services include the supply of electric generation capacity for utilities and peak-shaving services for commercial and industrial customers, the provision of temporary power for construction facilities, and backup power to off-grid customers.

### CROSS REFERENCE TO RELATED APPLICATIONS

This application is a continuation of International Patent Application No. PCT/US19/49282 filed Sep. 3, 2019. PCT/US2019/049282 claims benefit of priority to U.S. Provisional Patent Application 62/726,901 filed Sep. 4, 2018. Each of these priority applications is incorporated herein by reference in its entirety.

### FIELD OF THE INVENTION

The invention relates generally to storing electric energy and to charging electric vehicles.

### BACKGROUND

Nearly all major automakers are bringing 100% electric vehicles to market that seek to rival traditional passenger cars in form, fit, and function. Until recently, these cars were limited in their range, which was typically 100 miles. Newer EV models now have the ability to drive over 200 miles on a single charge, seen by many analysts as a key threshold. Examples are the Chevy Bolt (225-mile range) and the Tesla Model 3 (210-310 mile range). As lithium-ion battery prices and costs for EVs continue to decline, electric vehicles should similarly decline in price and, due to numerous performance advantages like acceleration, convenience, and lower maintenance costs, 200+ mile EVs have the potential to become consumers' car of choice. There is one major commercial barrier, however: charging stations. For the market in EVs to really scale, there needs to be a broad charging solution that is similar in convenience to gasoline filling stations.

The energy capacity in a battery pack on a 200-mile EV is typically 50 kWh or greater. In the United States today, there are currently about 2500 so-called DC “fast-charging” stations, the vast majority of which are 50 kW in size. At a 50 kW charge rate, it will take a 200+ mile EV over one hour to charge.

That is a major problem in scaling EVs. Few consumers want to wait a full hour to charge their car on a long-range trip. This is the reason why some manufacturers in the European auto industry are examining moving to a standard of 350 kW for EV DC fast charging. At a 350 kW charge rate, it will take a 200-mile EV with a 50 kWh battery pack about 10 minutes to charge, which will be comparable in experience to filling up a car with gasoline.

As the auto industry works to increase the charging rate that EVs can handle to the 200 kW and up range, there is a corresponding need to build out nationwide charging infrastructure that can provide DC fast charging at rates of 200 kW and higher. At a charge rate of 200 kW, a 50 kWh battery pack can be fully charged in as little as 15 minutes. However, such a charge rate leads to a second element in the EV scale-up problem: DC fast charging stations in the 100 kW and up size range are expensive and risky to build, primarily due to the mismatch between cost and expected revenue from a new EV charging station.

A late-2017 study by Dubois & King for the Vermont Energy Investment Corporation found that EV DC fast-charging stations (DCFC) in the 120 kW range will cost on the order of $110K merely to physically connect the DCFC to the grid. On top of that, there is the equipment cost for the DCFC (estimated by D&K to be another $100K). A third expense for those same 120 kW fast charging stations—if installed without energy storage—are the annual utility demand charges of $20,000 per year which, on a net-present-value (NPV) basis, is about $280,000.

Scaling these figures (and applying some efficiencies of scale) means that a 200- or 300-kW DC fast charging station that delivers instantaneous power from the grid will cost on the order of $200K to build and could face utility demand charges on the order of $500K NPV. This means that a DC fast charger in the 200 kW range will have to generate revenue in the $700K range to simply break even. If one assumes a parity-with-gasoline cost of $3 (which is $25 for a 250-mile fill-up @ 30 mpg), that translates to 28,000 charges for a simple payback, or 19 years assuming four complete charges per day from the DC fast charger. Most businesses look for a two-year simple payback. Speculative businesses even shorter.

Thus, there is significant barrier if the electric and automotive industries are to scale to provide the DC fast charging infrastructure that is needed in a cost-effective manner. EVs will not scale if there is not a robust charging infrastructure in place, and the charging infrastructure will not happen until a much lower-cost solution is found for the chargers. Indeed, according to Bloomberg New Energy Finance (BNEF), low-cost DC fast charging is likely to be the most significant barrier to scale-up of EVs. Writing in their 2017 Annual Electric Vehicle Outlook, BNEF states: “Even when EVs have reached cost parity with internal combustion engine vehicles, lack of home charging [for car-owners without homes] will be a significant barrier to adoption and will restrict EV sales from reaching 100%. In our models, many countries that grab an early lead in EV adoption (China, U.S., parts of Europe) hit this ‘infrastructure cap’ in the mid-2030s and sales growth slows significantly.”

Many EV charging providers like ChargePoint—arguably America's leading EV charging solution provider—are working on solutions that involve battery storage as a means of managing the costly utility demand charges. The current thinking is to install battery storage at the location of the stationary charger in a 20-year type of installation. Storage adds to the capital cost but helps to avoid the utility demand charges, which are applied if electricity use occurs during the peak period, typically in the period from 12 noon-8 PM weekdays. The charges are on the order of $20 per kW-month, which translates to $4,000 per month for a 200 kW charger if charging occurs during the utility's peak period. These demand charges are generally avoided or reduced if an adjacent battery is able to charge during the off-peak hours and then provide the power to the DC fast charger during the utility's peak period, instead of that power coming from the grid.

A web survey of the large EV charging companies indicates that this conventional thinking is broadly shared; i.e., that the best use of storage is to permanently install it at the fixed location of the DC fast charger.

Unfortunately, the approach of providing stationary storage along with a fixed DC fast charger is still inherently expensive. Consider, for example, the infrastructure changes necessary to install a 200 kW charging station at a typical location like a gas station. Assuming a given gas station (in the US) has 480V, 3-phase service, at this voltage, there is approximately 1.2 amps per kVA. Assuming a 90% charger/circuit efficiency, a 200 kW fast charger will draw (200×1.2)/(0.90)=265 Amps. Since the regulatory code will likely consider this a continuous load, a 1.25 safety factor will be required: 265 amps×1.25=331 Amps. Most gas stations, depending on size, won't have anywhere near 331 Amps of unused electrical service capacity. Furthermore, it's more likely that an existing gasoline service station has a single-phase service entrance section (SES). Alternately, it could have a three phase 120/208 volt SES. In either case, a new utility feed and a new SES would be required.

Consequently there are at least nine different physical upgrades typically needed to install a new DC fast charger at such a location. Three must be made by the electric utility, and six by the gas-station host. Utility upgrades include a new underground (UG) 12 to 21 kV primary electric service extension, a 3 Phase, (12 to 21 kV)/480V pad-mounted step-down transformer, and underground service conductors and metering equipment between the step down transformer and the electrical service entrance section (SES). Customer (DC fast-charger host) upgrades include a new, dedicated 400-Amp UG SES, including support structure and/or a concrete pad for the SES, a 400-Amp circuit breaker, 331+/−Amp underground feeder from the SES to the charger station including underground cable, trench, and conduit, the DC Fast Charger and its pad, battery storage (if desired), and a new 480V to 120/240/208 dry-type step-down transformer to service the original electric gas station loads.

### SUMMARY

In order for electric vehicles (EVs) to move from a niche position in the automotive market to the dominant car of choice, a robust national electric DC fast-charging (DCFC) infrastructure is required that can provide fast fill-ups (10 min or less) to EVs. Currently, costs to build that national infrastructure are prohibitively high. This specification presents a low-cost solution using mobile, energy storing, electric-vehicle DC fast-charging units.

As they are fundamentally an electric-energy storage device, the same mobile charge units (MCU) can be further configured to provide a number of AC or DC power services to utilities, utility customers, and off-utility-grid customers. It is expected that a given mobile charge unit could, over its useful life, provide a variety of EV, grid-connected, and off-grid services from one single platform.

### BRIEF DESCRIPTION OF THE DRAWINGS

FIG. 1 illustrates a mobile charging unit (MCU) as used in some variations of the present invention.

FIG. 2 illustrates a charging hub service area as per some variations of the present invention.

FIG. 3 illustrates an electrical 1-line diagram of an example MCU charging hub.

FIG. 4 illustrates an example system for marketing and managing a fleet of MCUs.

FIG. 5 illustrates an example computer architecture that may be used to implement embodiments of the present disclosure, for example, the mobile devices and computer servers for implementing the example MCU marketing and management system of FIG. 4.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

This specification presents a cost-saving alternative to the traditional, fixed-station DC fast-charging mindset: a mobile, energy storing, DC fast charger that can be easily moved from a charging hub to a different, vehicle-charging location. This approach does not require the electrical service upgrades described above for a stationary DC fast charger located at the site at which vehicles are charged. In some variations this approach allows grid charging of the mobile DC fast charger to occur at a remote low-cost location (i.e., a charging hub), for example at night or at other periods during which the cost of electricity is low. Once charged at the charging hub, a mobile unit can then be delivered to various remote locations for charging of electric vehicles at a much lower total lifecycle cost.

The mobile DC fast charger may store energy chemically, electrically, mechanically, or by any other suitable storage mechanism. For example, the mobile DC fast charger may store energy in one or more electric batteries (e.g., Lithium-ion batteries), one or more flow batteries, one or more capacitors, or in one or more spinning flywheels. In such cases the electric batteries and or capacitors may be electrically recharged from the grid at a charging hub, the flow batteries may be recharged with fresh electrolytes delivered to the mobile charger or loaded at a charging hub, and spinning flywheels may be recharged from the grid at a charging hub using an electrically powered drive to spin up the flywheel.

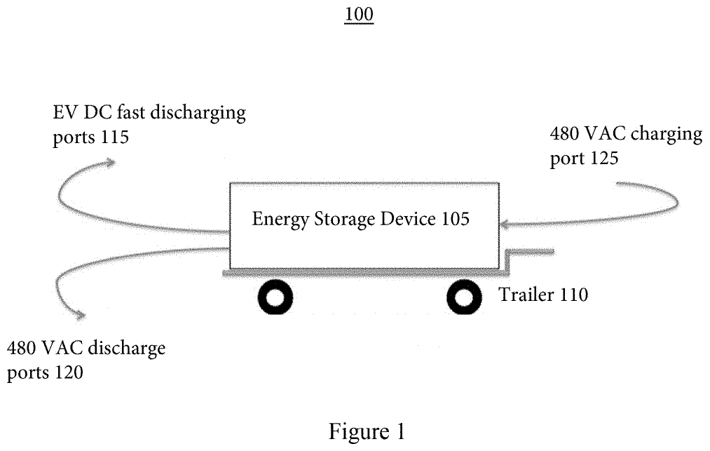

FIG. 1 depicts an MCU 100 comprising an energy storage device 105 mounted on a trailer 110. Energy storage device 105 is configured for example to provide a DC fast charge of 200 kW with 400 kWh of stored energy through one or more EV DC fast-discharging ports 115, or six complete 65 kWh EV fill-ups. In the illustrated example, energy storage device 105 is or comprises one or more Lithium-ion batteries, which may be charged via a 480 VAC charging port 125. Trailer 110 may have physical dimensions allowing it to easily fit in a standard automobile parking space. As further described below, storage device 105 may also comprise one or more 480 VAC discharge ports 120.

The MCUs can be built with materials that are commercially available today, such as for example: 1) Lithium-ion battery cells, 2) bi-directional inverters, 3) manufacturer battery management systems, 4) DC fast charging components, cables and plugs, 5) wireless communication equipment for remote monitoring of the health of the units, as well as for processing of commercial transactions, 6) local, remote credit- and debit-card transaction-processing systems, and 6) a master control system that manages overall operation and control of the unit.

An alternate version of the MCUs using the high-level components described above lacks a bi-directional inverter. Instead, a one-directional or bi-directional inverter is installed at the charging hub. This would realize a savings in that the total number of inverters could be reduced from the total count of MCUs being serviced by the hub to the smaller number of MCUs that can be charged simultaneously at the charging hub.

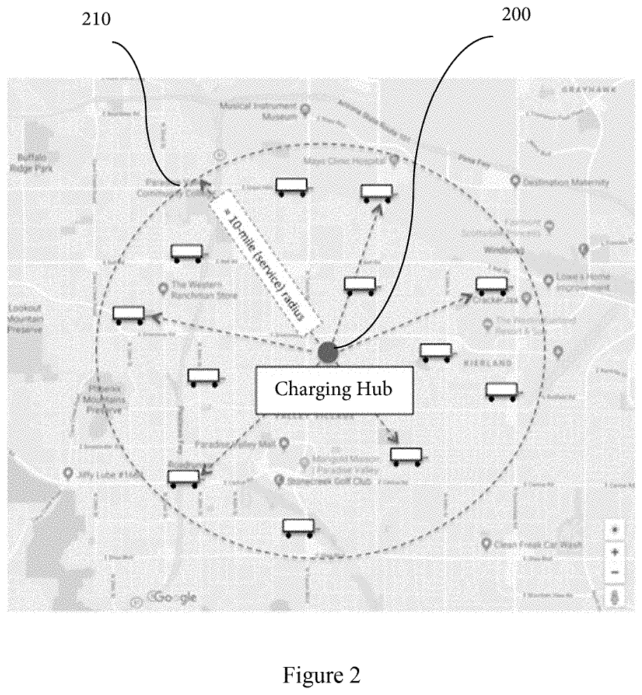

As explained above, a series of these mobile EV chargers may be charged at one or more low-cost charging locations (hubs) and then deployed within a reasonable radius/distance from hub to provide daytime charging needs. FIG. 2 demonstrates how one charging hub 200 could service a geographical area within, for example, a typical 10-mile service radius 210.

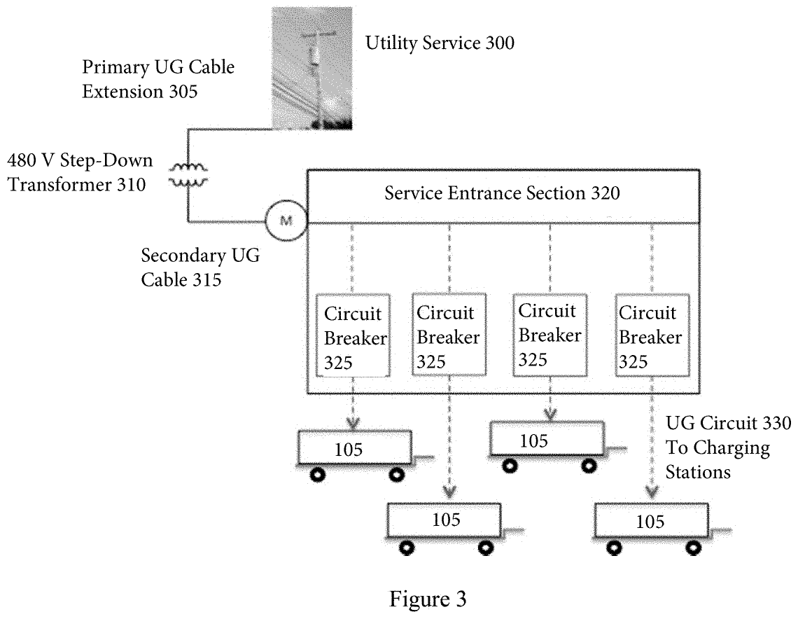

As further discussed below, the charging hub may advantageously be located at an existing location on the grid having suitable electrical service that is unused during portions of the day, and thus available to charge MCUs. An alternative to tapping into existing commercial and industrial circuits is to procure an existing, low-cost location (e.g., a warehouse) where the charging can be done. FIG. 3 illustrate the electrical infrastructure and upgrades that might be necessary to charge four MCU simultaneously at a charging hub. No utility upgrades are likely to be required. The electrical infrastructure includes utility service 300 of typically 12 to 21 kV, existing primary underground cable extension 305, existing 480 V step-down transformer 310, existing secondary underground cable and conduit 315, and existing 1200 amp (or larger) service entrance section 320. Upgrades include four 400-Amp circuit breakers 325, and 331+/−Amp underground feeder(s) 330 from the service entrance section to the charger stations for the MCUs, including underground cable, trench, and conduit. Pavement and other repairs to streets and parking lots needed for the underground service runs may also be needed.

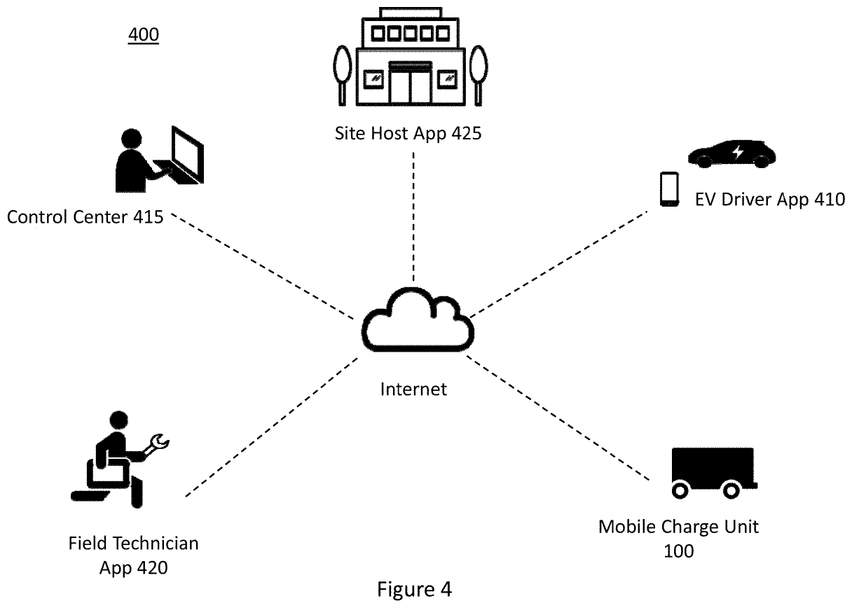

FIG. 4 is a block diagram schematically showing an example system 400 for marketing and managing a fleet of MCUs 100, with the various software and hardware elements in the system optionally communicating with each other wirelessly and/or through the internet 405. Although only one MCU is shown in FIG. 4, the fleet of MCUs may comprise for example one or more, two or more, ten or more, twenty or more, fifty or more, or one hundred or more MCUs.

Referring to FIG. 4, EV Driver/customer smart-phone App 410 provides location-based information to the App user regarding where MCUs are located and providing EV-charging services in the App user area, or in an area where the App user might be traveling to in the future. Step-by-step navigation can guide the App user to a selected MCU, which will typically (but not necessarily) be the closest MCU to the App user. The App may include a reservation system, by which the App user can reserve an EV-charging session at a given location for a specific block of time. The App may provide for prepayment of the service. The App may also include a voting system by which App users can vote and make suggestions where MCUs should be parked on given days, so that the MCU fleet owner or operator can be informed on where to located future MCUs so EV drivers can access them for EV-charging services. The App may allow and customer to view estimated future demand-based pricing, and to view personal history (e.g., number of charges, average kWh, total kWh, total green kWh, average cost, total cost). App 410 may be downloaded in a typical smart-phone App store to the EV-driver's (or another's) phone or smart device. App 410 may instead be downloaded and used from a tablet or other computer device. Although only one App 410 is shown in FIG. 4, system 400 typically includes many such EV/customer Apps.

A control center 415 allows an operator to remotely monitor the entire MCU fleet or a subset of the fleet for system status, health, alarms, MCU energy storage (e.g., battery) state of charge, and other diagnostic information. The control center may also analyze hub and fleet performance (kWh, charge costs, revenues, etc.), maintain/modify the fleet deployment calendar, and communicate with and respond to requests from hosts, customers (EV drivers and/or passengers), and service technicians. The control center communicates, for example, via a cloud-based platform whereby a server connected to the cloud communicates with individual MCUs in the field via cellular, radio, fiber, or other standard means of communication and presents this information to the operator via a human-machine interface. The operator can issue remote commands from the control center in real-time and/or adjust system settings on one or more MCUs on a time- or conditions-based basis and send information and/or service requests to technicians in the field. Although only one control center 415 is shown in FIG. 4, system 400 may comprise one or more such control centers.

A Field Technician App 420 (FTA) provides a technician with the ability to monitor the fleet of MCUs in his/her service territory for health, condition, state of charge, and other diagnostic information. The field technician can also receive service requests from the control center 415 from time to time and send information back in return to the control center via the FTA 420. The FTA may include a service-log element to remind the technician what kinds of services are needed and when, as well as to enter dates, times, and other measurement and diagnostic information into the FTA for record-keeping. The FTA may minimize total travel time for the technician by optimizing routes to MCUs requiring service. FTA 420 may be downloaded to a tablet or other smart device that a technician can use in the field, or to any other suitable computer device. Although only one FTA 420 is shown in FIG. 4, system 400 typically includes one or more such Field Technician Apps, depending on the number of field technicians employed in maintaining the system.

A Site-Host App (SHA) 425 may be accessed and used by a grocery, retail, or other site host who has given authorization for an MCU to be parked at their facility. The SHA may be used by a site host to, for example, request/bid on and reserve future dates and quantities of delivery of MCUs, to rent/lease MCUs for on-site power (e.g., construction, events), and to procure back-up power. The SHA, when downloaded to a smart device and given the customer user permissions to monitor the local units, can present various pieces of information to the site host that he/she may be interested in. Such information may include the number of charging sessions, the duration of the sessions, state of charge of a given MCU, and the like, and may be tied to customer behavior in their store (such as purchases) through linkage of credit-card and other information. Although only one SHA 425 is shown in FIG. 4, system 400 typically includes one or more such Site Host Apps, depending on the number of site hosts operating in the system.

Taken comprehensively, the MCU-based EV-charging design, coupled with some or all of the elements of example system 400 described above, should realize significant savings and overall life-cycle cost effectiveness compared to a stationary DC fast-charger solution. Consider for example the following advantages to such an approach.

Speed to market. Rather than install a fixed location DC fast charger, a gas station operator (or similar) can instead request delivery of a mobile DC fast charger. Within a day or two, for example, a mobile, fully charged DC fast charging station arrives from a local provider. There is no need to tear up the parking lot and significantly upgrade the capacity of the electrical service, and little or no design or permitting required. The speed to market to deliver a solution to a customer happens within days, rather than months.

Demand-charge savings. A second cost-saving efficiency comes from the ability of a mobile charge unit to charge when a utility's demand charges are either zero or at a much lower off-peak rate. As discussed earlier, utilities apply charges to their customers for energy delivered (kWh) and demand (kW, determined by the maximum 15 minutes of kW load during the peak period in a given month; typically between 11 AM and 9 PM weekdays). Most utilities charge only for on-peak demand, which runs around $15 to $20 per kW-month. A smaller subset of utilities not only apply an on-peak demand charge, but also assess an off-peak demand charge of $5 to $10 per kW month (for the maximum 15-minute demand interval that occurs during the off-peak period). By charging the MCUs at off-peak, nearly all demand-charges can be eliminated, resulting in significant NPV savings per DCFC.

Reduced cost to physically connect to the grid. A third cost efficiency with a mobile, trailer-mounted or autonomous-driving solution comes by leveraging existing, low-cost places of interconnection of the DCFC to the grid. There are a great many places in the grid where MWs of electrical service to existing customers have already been installed that goes nearly fully unutilized at night. That is because the lights, AC, and other equipment that many customers run during the day are often not powered at night. Examples of customers that have large daytime and nighttime differences in their power use include churches, elementary and secondary schools, municipal locations, and various medium to large commercial and industrial electric customers. Many of these utility customers have existing, high-capacity circuits at 480 VAC, which is the ideal, standard input voltage for commercially available bi-directional battery inverters that would be installed on a mobile charging unit. By arranging charging at a remote facility where one or more of these existing electric circuits are readily available for nighttime charging, followed by an early morning run over to a remote daytime parking location where DC fast charging services to electric vehicles can be provided, significant savings can be realized in the cost to connect the MCU to the grid.

Lower host-transaction costs for the DCFC solution provider. A fourth efficiency comes in the form of being able to simplify the significant legal and transaction costs associated with getting DCFCs installed. Chosen well, there can be a variety of charging station hubs that can charge not only one or two mobile batteries at low cost, but ten, twenty, or even fifty units. Once a suitable hub is secured, the incremental step of getting the MCUs deployed within a 10-mile (illustrative) service radius should be relatively straightforward (and inexpensive).

This should allow significant savings in transaction costs between the DCFC station owner and the host of the facility—like a grocery store—where the DCFC will provide EV charging services over the course of a day. That's because the contract that's needed can be month-to-month, and thus considerably cheaper to negotiate and close, instead of a 10- to 20-year contract.

To get a sense of what these savings could be, consider that the National Renewable Energy Lab (NREL) compiles the solar industry customer transaction costs associated with solar leases and solar power purchase agreements (PPAs) between installers and hosts. In many respects, the commercial structure of a solar PPA and a fixed location DCFC station are comparable. Similarities include negotiating a fee to lease the host's property for a 10- to 20-year basis, installing electrical power equipment behind the host's utility electric billing meter, determining how to handle flows and credits of electric power behind the billing meter, issues of indemnification, access and egress, and so on.

In their 2017 annual report (Ran Fu et al, US Solar Photovoltaic System Cost Benchmark: Q1 2017, NREL, 2017, p. 31), NREL reported that the customer transaction costs (which they call “customer acquisition costs”) for solar systems installed in the 10- to 2000-kW range were $0.42/Watt. Translating these to a 200 kW DCFC yields an estimated transaction cost of $80,000 per DCFC. There are reasons to think that the transactions costs for DCFC leases could be lower than those for solar systems, but even if the savings are lower by a factor of four, the transaction cost would still be $20,000 per 200 kW DCFC.

With the mobile charging solution described herein, such transaction costs can be reduced by a factor of ten or more, simply due the much lower number of complicated, long-term contracts (for example, 10 for a fixed location charger strategy versus 1 for a strategy using mobile charging units and a low-cost charging hub).

For a variety of reasons, fixed-location DC fast charging stations are likely to experience cost, schedule, and risk challenges in meeting the charging needs of a rapidly growing EV market. Mobile DC fast-charging units as described herein represent a compelling solution that can incrementally scale to meet the charging needs of the growing EV market.

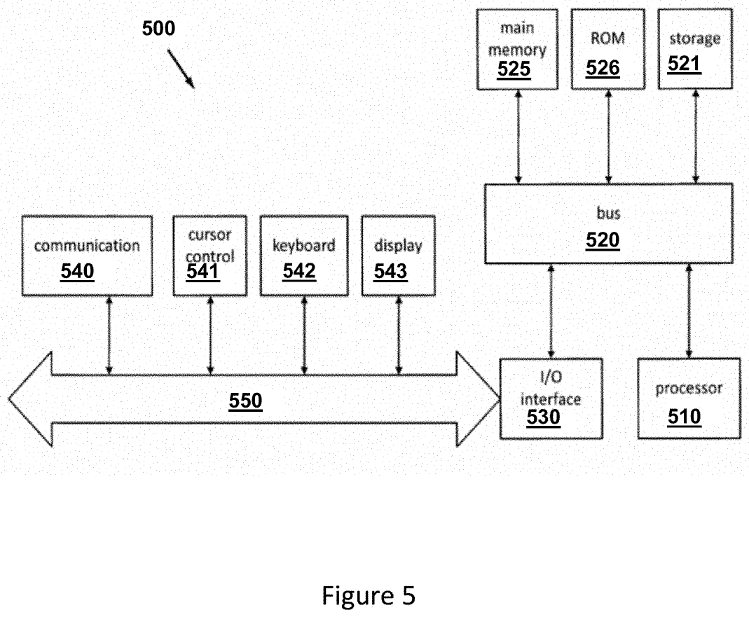

FIG. 5 illustrates an example computer architecture that may be used to implement embodiments of the system 400 described above as well as related methods. The example computer architecture may be used for implementing one or more components described in the present disclosure including, but not limited to, mobile devices, computer servers for supporting operation of system 400 and other computerized devices. One embodiment of architecture 500 comprises a system bus 520 for communicating information, and a processor 510 coupled to bus 520 for processing information. Architecture 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Architecture 500 may also include a read only memory (ROM) and/or other static storage device 526 coupled to bus 520 for storing static information and instructions used by processor 510.

A data storage device 521 such as a magnetic disk or optical disc and its corresponding drive may also be coupled to architecture 500 for storing information and instructions. Architecture 500 can also be coupled to a second I/O bus 550 via an I/O interface 530. A plurality of I/O devices may be coupled to I/O bus 550, including a display device 543, an input device (e.g., an alphanumeric input device 542, a cursor control device 541, and/or a touchscreen device).

The communication device 540 allows for access to other computers (e.g., servers or clients) via a network. The communication device 540 may comprise one or more modems, network interface cards, wireless network interfaces or other interface devices, such as those used for coupling to Ethernet, token ring, or other types of networks.

The following numbered clauses provide additional non-limiting aspects of the disclosure.

A1. A method, comprising:
charging an electric battery in a mobile direct-current electric-vehicle charger at a first location at a direct-current charging rate of 50 kW or greater for the purpose of storing the energy for later use;
transporting the partially or fully charged mobile electric-vehicle charger to a second location; and
using the partially or fully charged mobile electric-vehicle charger to charge one or more electric vehicles at the second location at a direct-current charging rate of 50 kW or greater.

A2. The method of clause A1, comprising charging the direct-current electric-vehicle charger at the first location at a direct-current charging rate of 200 kW or greater, or of 400 kW or greater.

A3. The method of clause A1 or clause A2, wherein the electric battery has a full energy charge capacity of greater than or equal to 100 kWh, or greater than or equal to 400 kWh.

A4. The method of any of clause A1-A3, wherein the mobile direct-current electric-vehicle charger comprises one or more electric-vehicle direct-current charging discharge ports and one or more 480 volt alternating current discharge ports.

A5. The method of any of clause A1-A4, wherein the first location comprises 12 kV to 21 kV alternating current primary electric service, and/or other voltages that are considered to be medium-voltage class service, coupled to a 3-phase 12 kV to 21 kV/480 V (or similar) transformer used to charge the electric battery. Secondary (480 VAC) and transmission-level (69 kV and up) voltages may be used to charge the MCU as well.

A6. The method of clause A5, wherein the primary electric service at the first location also serves a commercial or industrial facility at or adjacent to the first location.

A7. The method of any of clause A1-A6, wherein the second location is adjacent to or comprises a commercial facility.

A8. The method of clause A7, wherein the commercial facility is or comprises an automobile service station providing liquid fuel for automobiles.

A9. The method of any of clause A1-A8, comprising charging the electric battery at night.

A10. The method of any of clause A1-A9, comprising charging the electric battery during a period of reduced electric power rates.

A11. The method of any of clause A1-A10, comprising charging the electric battery during a time period that avoids some or all utility demand charges.

A12. The method of any of clause A1-A11, comprising discharging the electric battery into the electric power grid from which it was charged.

A13. The method of any of clause A1-A12, comprising having the mobile electric-vehicle charger retrieved from the second location and then recharging it.

A14. A method, comprising:
charging an electric battery in a mobile direct-current electric-vehicle charger at a first location at a direct current charging rate of 50 kW or greater for the purpose of storing the energy for later use; and
having the partially or fully charged mobile electric-vehicle charger transported to a second location at which the mobile electric-vehicle charger may be used to charge one or more electric vehicles at a direct current charging rate of 50 kW or greater.

A15. The method of clause A14, wherein at the second location the mobile electric-vehicle charger may be used to charge one or more electric vehicles at a direct current charging rate of 200 kW or greater, or of 400 kW or greater.

A16. The method of clause A14 or clause A15, wherein the electric battery has a full energy charge capacity of greater than or equal to 100 kWh or greater than or equal to 400 kWh.

A17. The method of any of clauses A14-A16, wherein the mobile direct-current electric vehicle charger comprises one or more electric-vehicle direct-current charging discharge ports and one or more 480 volt alternating current discharge ports.

A18. The method of any of clauses A14-A17, wherein the first location comprises 12 kV to 21 kV alternating current primary electric service coupled to a 3 phase 12 kV to 21 kV/480 V transformer used to charge the electric battery.

A19. The method of clause A18, wherein the primary electric service at the first location also serves a commercial or industrial facility at or adjacent to the first location.

A20. The method of any of clauses A14-A19, wherein the second location is adjacent to or comprises a commercial facility.

A21. The method of clause A20, wherein the commercial facility is or comprises an automobile service station providing liquid fuel for automobiles.

A22. The method of any of clauses A14-A21, comprising charging the electric battery at night.

A23. The method of any of clauses A14-A22, comprising charging the electric battery during a period of reduced electric power rates.

A24. The method of any of clauses A14-A23, comprising charging the electric battery during a time period that avoids some or all utility demand charges.

A25. The method of any of clauses A14-A24, comprising discharging the electric battery into the electric power grid from which it was charged.

A26. The method of any of clauses A14-A25, comprising having the mobile electric vehicle charger retrieved from the second location and then recharging it.

A27. A method comprising:
requesting delivery to a second location of a fully or partially charged mobile direct current electric vehicle charger that comprises a battery that has been charged at a first location at a direct current charging rate of 50 kW or greater for the purpose of storing the energy for later use; and
using the mobile electric vehicle charger to charge one or more electric vehicles at the second location at a direct current charging rate of 50 kW or greater.

A28. The method of clause A27, comprising using the mobile electric vehicle charger to charge one or more electric vehicles at the second location at a direct current charging rate of 200 kW or greater or of 400 kW or greater.

A29. The method of clause A27 or clause A28, wherein the electric battery has a full energy charge capacity of greater than or equal to 100 kWh or greater than or equal to 400 kWh.

A30. The method of any of clauses A27-A29, wherein the mobile direct-current electric-vehicle charger comprises one or more electric vehicle direct-current charging discharge ports and one or more 480 volt alternating current discharge ports.

A31. The method of any of clauses A27-A31, wherein the first location comprises 12 kV to 21 kV alternating current primary electric service coupled to a 3 phase 12 kV to 21 kV/480 V transformer used to charge the electric battery.

A32. The method of clause A31, wherein the primary electric service at the first location also serves a commercial or industrial facility at or adjacent to the first location.

A33. The method of any of clauses A27-A32, wherein the second location is adjacent to or comprises a commercial facility.

A34. The method of clause A33, wherein the commercial facility is or comprises an automobile service station providing liquid fuel for automobiles.

A35. The method of any of clauses A27-A34, wherein the electric battery was charged at night.

A36. The method of any of clauses A27-A35, wherein the electric battery was charged during a period of reduced electric power rates.

A37. The method of any of clauses A27-A36, wherein the electric battery was charged during a time period that avoids some or all utility demand charges.

B1 A method, comprising:
charging energy storage devices in a fleet of one or more mobile direct-current electric-vehicle chargers (MCUs) at a first location; and
transporting the MCUs to one or more secondary locations at which the MCUs are to be used to charge one or more electric vehicles.

B2. The method of clause B1, wherein the fleet comprises two or more MCUs.

B3. The method of clause B1, comprising transporting at least one of the MCUs to its secondary location in response to a request received as one or more electronic signals from a host entity at the secondary location.

B4. The method of clause B1, comprising transporting at least one of the MCUs to its secondary location in response to one or more requests received as one or more electronic signals from one or more electric vehicle operators or passengers.

B5. The method of clause B1, comprising retrieving an MCU having a partially or fully discharged energy storage device from one of the secondary locations and recharging the energy storage device at the first location.

B6. The method of clause B5, comprising retrieving the MCU in response to an electronic signal received from the MCU reporting the charge in the energy storage device.

B7. The method of clause B5, comprising retrieving the MCU in response to an electronic signal received from an entity hosting the MCU at one of the secondary locations.

B8. The method of clause B1, comprising transporting one of the MCUs from one of the secondary locations to another location at which it is to be used to charge one or more electric vehicles.

B9. The method of clause B8, comprising transporting the MCU to the other location in response to an electronic signal from a host entity at the other location.

B10. The method of clause B8, comprising transporting the MCU to the other location in response to one or more electronic signals received from one or more electric vehicle drivers or passengers.

B11. The method of clause B1, comprising dispatching a service technician to one of the MCUs in response to an electronic signal from the MCU.

B12. The method of clause B11, wherein dispatching the service technician comprises sending a request to the service technician as an electronic signal.

B13. The method of clause B1, comprising dispatching a service technician to one of the MCUs in response to an electronic signal received from one or more electrical vehicle operators or passengers.

B14. The method of clause B1, comprising transmitting a signal to an electric vehicle driver or an electric vehicle passenger providing the location of one or more MCUs.

B15. The method of clause B14, comprising transmitting a signal to the electric vehicle driver or the electric vehicle passenger reporting the charge status of the one or more MCUs.

B16. The method of clause B14, comprising transmitting a signal to the electric vehicle driver or to the electric vehicle passenger concerning reserving a time to charge the electric vehicle from one of the MCUs.

B17. The method of clause B1, comprising charging the energy storage devices during a period of reduced electric power rates.

B18. The method of clause B1, comprising charging the energy storage devices during a time period that avoids some or all utility demand charges.

B19. The method of clause B1, comprising discharging at least one of the energy storage devices into an electric power grid from which it was charged.

B20. The method of clause B1, comprising discharging at least one of the energy storage devices into an electric power grid other than an electric power grid from which it was charged.

B21. The method of clause B1, comprising charging an electric vehicle using one of the mobile direct-current electric-vehicle chargers at one of the secondary locations.

B22. A method comprising:
requesting delivery to a second location of one or more of a fleet of one or more MCUs each comprising an energy storage device charged at a first location.

B23. The method of clause B22, wherein the fleet comprises two or more MCUs.

B24. The method of clause B22, comprising charging an electric vehicle using the MCU at the second location.

B25. The method of clause B22, comprising using at the second location alternating current electric service provided by the MCU.

B26 The method of clause B22, comprising requesting retrieval of the MCU from the second location after its energy storage device is partially or fully discharged.

B27. The method of any of clauses B1-B26 wherein the MCUs are configured to charge electric vehicles at a direct current charging rate of 50 KW or greater.

B28. The method of clause B27 wherein the MCUs are configured to charge electric vehicles at a direct current charging rate of 100 KW or greater.

B29. The method of clause B28, wherein the MCUs are configured to charge electric vehicles at a direct current charging rate of 200 KW or greater.

B30. The method of clause B29, wherein the MCUs are configured to charge electric vehicles at a direct current charging rate of 400 KW or greater.

B31. The method of any of clauses B1-B26, wherein the energy storage devices each have a full energy charge capacity of greater than or equal to 100 kWh.

B32. The method of clause B31, wherein the energy storage devices each have a full energy charge capacity of greater than or equal to 400 kWh.

This disclosure is illustrative and not limiting. Further modifications will be apparent to one skilled in the art in light of this disclosure and are intended to fall within the scope of the appended claims.

What is claimed is:

1. A method, comprising:
charging energy storage devices in a fleet of one or more mobile direct-current electric-vehicle chargers (MCUs) at a first location; and
transporting the MCUs to one or more secondary locations at which the MCUs are to be used to charge one or more electric vehicles.

2. The method of claim 1, comprising retrieving an MCU having a partially or fully discharged energy storage device from one of the secondary locations and recharging the energy storage device at the first location.

3. The method of claim 1, comprising transporting one of the MCUs from one of the secondary locations to another location at which it is to be used to charge one or more electric vehicles.

4. The method of claim 1, comprising dispatching a service technician to one of the MCUs in response to an electronic signal from the MCU.

5. The method of claim 4, wherein dispatching the service technician comprises sending a request to the service technician as an electronic signal.

6. The method of claim 1, comprising dispatching a service technician to one of the MCUs in response to an electronic signal received from one or more electrical vehicle operators or passengers.

7. The method of claim 1, comprising transmitting a signal to an electric vehicle driver or an electric vehicle passenger providing the location of one or more MCUs.

8. The method of claim 7, comprising transmitting a signal to the electric vehicle driver or the electric vehicle passenger reporting the charge status of the one or more MCUs.

9. The method of claim 7, comprising transmitting a signal to the electric vehicle driver or to the electric vehicle passenger concerning reserving a time to charge the electric vehicle from one of the MCUs.

10. The method of claim 1, comprising charging the energy storage devices during a period of reduced electric power rates.

11. The method of claim 1, comprising charging the energy storage devices during a time period that avoids some or all utility demand charges.

12. The method of claim 1, comprising discharging at least one of the energy storage devices into an electric power grid from which it was charged

13. The method of claim 1, comprising discharging at least one of the energy storage devices into an electric power grid other than an electric power grid from which it was charged.

14. The method of clam 1, comprising charging a plurality of electric vehicles using one of the mobile direct-current electric-vehicle chargers at one of the secondary locations.

15. The method of claim 1, wherein the MCUs are configured to charge electric vehicles at a direct current charging rate of 50 KW or greater.

16. The method of claim 15 wherein the MCUs are configured to charge electric vehicles at a direct current charging rate of 100 KW or greater.

17. The method of claim 16, wherein the MCUs are configured to charge electric vehicles at a direct current charging rate of 200 KW or greater.

18. The method of claim 17, wherein the MCUs are configured to charge electric vehicles at a direct current charging rate of 400 KW or greater.

19. The method of claim 1, wherein the energy storage devices each have a full energy charge capacity of greater than or equal to 100 kWh.

20. The method of claim 19, wherein the energy storage devices each have a full energy charge capacity of greater than or equal to 400 kWh.
